(19) United States
(12) Patent Application Publication
(10) Pub. No.: US 2020/0013093 A1
(43) Pub. Date: Jan. 9, 2020

(54) SYSTEM AND METHOD FOR ASYNCHRONOUS ONLINE ADVERTISEMENT BIDDING USING AN OPEN SOURCE PUBLIC NETWORK OF CURRENT AND PAST USER DATA

(71) Applicant: BRADLEY RICHARD BROOKS, BEVERLY HILLS, CA (US)

(72) Inventor: BRADLEY RICHARD BROOKS, BEVERLY HILLS, CA (US)

(21) Appl. No.: 16/027,133

(22) Filed: Jul. 3, 2018

(51) Int. Cl. G06Q 30/02

(52) U.S. Cl. CPC G06Q 30/0275; G06Q 30/0215; G06Q 30/0277

(57) ABSTRACT

The disclosed systems and methods improve on the current landscape surrounding autonomous “programmatic” advertising. The systems and methods incorporate an open source library that advertising publishers can deploy as an auction clearinghouse, setting a universal timeout and comparing all of the responses before sending the winning bids to the publisher's ad server. As an improvement, the present invention further stores the meta data associated with a winning bid on a specialized network for conducting asynchronous communications. This stored or “historical bid data” is then used to improve the speed, efficiency, profitability, and yield of online advertising. In addition, while traditional methodology for pre-bidding only benefits the publishers, the present invention suggests systems and methods wherein users and publishers may participate and be compensated for providing targeted bid data through either FIAT or cryptocurrency.

### BACKGROUND OF THE INVENTION

Programmatic Advertising is a process that allows for the automated buying and selling of media inventory. The advent of ‘programmatic’ has allowed countless publishers to monetize their content without having to employ a large number of direct salespeople to call on brands and agencies. In fact, programmatic has become so large that it now dwarfs direct-sold campaigns in terms of a volume, with nearly 180 billion impressions being served each day.

Header bidding tags emerged in 2015 in large part as a reaction to the monopoly by a few large publishers in the ad serving market. Its platform was opaque and put every other ad exchange at a relative disadvantage since the larger advertisers always had more data. Importantly for publishers it remained unclear if they were always getting the best price for a given ad impression.

While Header Bidding has helped increase advertiser competition and information transparency, the ad tech industry is still riddled with inefficiencies that can be improved by the blockchain. Due to the nature of second price bidding, unauthorized reselling and the asymmetry of information between DSP's and publishers, there are often cases where an advertiser is willing to pay much more for an impression then a publisher receives.

The invention disclosed herein presents an improvement on programmatic advertising.

### SUMMARY OF THE INVENTION

Programmatic advertising is a process that allows for the automated buying and selling of media inventory. The present invention provides an improvement to programmatic “pre-bidding” or “header bidding” in online advertising by pooling, analyzing, and redistributing data related to specific users and bids in successful auctions. The previously unavailable data is pooled from various publishing sources, and is stored on an open source network. By leveraging this pool of data, the publishers will have the benefit of optimized bids on online advertisement platforms. Such an improvement will further increase the profitability, yield, speed, and efficiency of online advertising. Moreover, it provides a method by which the users themselves can participate in the pre-bidding process by volunteering their data.

Despite the positive uses for header bidding, smaller publishers have been unable to keep up with the larger ad publishers. In particular, major publishers continue to dominate the market through sheer volume. Moreover, advertisers remain unable to efficiently target a unique message to each individual recipient. As an example, if an advertiser buys a billboard space on a bench, many people will see the ad, but only a small percentage of viewers are potential buyers. The advertiser must make assumptions, perform analysis, draw conclusions of the surrounding areas, and increase the number of advertising. Through an iterative process the advertisement may result in increased business over time. However, the advertiser will need to repeat that same process when the ad is placed in a different environment.

This situation is analogous to problems with header bidding. While it is possible to ascertain certain information about users, the information is minimal and distributed amongst a variety of publishers. Accordingly, in an effort to remain competitive and profitable, Supply side platforms (“SSPs”) are always trying to source more advertising data. Thus, header bidding tags have had the negative side-effect of slowing down the load times of websites due to additional code and network calls. In addition, adding partners' header tags to websites has been time consuming and costly for publishers. Slower websites are now adopting blocking software to prevent header code.

While having access to as much advertising demand as possible is usually beneficial for publishers sometimes more demand can have the opposite effect as laid out in the following example:

Let's say a consumer, who happens to be in the market for a new car or some other large purchase, visits a publisher's website. Ad Buyer 1 knows that the user was recently at a car dealership submits a top bid of $20 to SSP 1. Because the second-highest bid was $3, SSP 1 submits a $3.01 bid back to the publisher's header bidding wrapper on behalf of the car buyer. Simultaneously, on SSP 2, Ad Buyer 2 submits a bid of $12 but because the second-highest bid in their auction was $4, SSP 2 submits a $4.01 bid. The wrapper then compares all of its bids from each SSP and selects the $4.01 from SSP 2.

So even though Ad Buyer 1 was willing to pay notably more than Ad Buyer 2, the dynamics of the auction awards the impression to Ad Buyer 2. Thus, the publisher receives $4.01 for a given piece of inventory instead the nearly 5× someone else was willing to pay.

Moreover, since header bidding occurs in real time, header bidding tags have also had the negative side-effect of burdening websites with additional code and network calls that significantly slowed loading times. When the amount of data to be transmitted is large, the user will wait for some time while the data is transmitted over the network. As a result, ever slower websites are thought to have accelerated adoption of ad blocking software, estimated at ˜20% of desktop users and ˜10% of mobile users in the US per eMarketer. This is particularly exaggerated wherein a user has slow broadband. Such a side effect has been particularly problematic for publishers, since, adding partners' header tag to websites is a time consuming and costly exercise.

In reaction, the advent of open sourced header bidding ‘wrappers’ in 2016 aimed to speed up loading times and make implementation of header bidding far easier to roll out and manage for large publishers. However, the wrappers have not completely solved the problem. The growing need to source larger amounts of data per page has decreased profitability and continued to slow pages.

The primary lever publishers have used combat the issues illustrated above is price “flooring.” However, executing this process dynamically on a per impression basis is incredibly difficult because of the information asymmetry that exists. Furthermore, if a publisher does not have a perfect understanding of what an advertiser is willing to pay for a user, a floor that is too high could cause a publisher to miss out on the impression altogether and serve no ad.

Accordingly, one embodiment of the current invention seeks to further analyze and store winning bid data and user data in an open source network. Such a system allows publishers to access large amounts of bid data and user data to improve price floors. Moreover, data analysis of the data will allow for a faster pre-bidding system.

Users are typically unaware or have no choice with respect to the use of their data. For example, if a user searches online for “Vacation to Las Vegas,” ads for cheap flights and hotel deals in Las Vegas may be found on other pages the user searches. Users typically do not have any control about the content they provide, and are typically not provided any compensation for this data. As a result, users are employing “ad blockers” to prevent their data from being used.

One conventional method for generating analytic data on website visitors is through the use of tags. In at least one conventional form, a tag is a hidden element within a webpage that causes some action to occur on a webpage when it is “fired.” In particular, in at least one implementation, a tag is a piece of code, e.g., JavaScript, that is placed within a webpage and allows a webpage owner to track information about the visitors who download and execute the particular piece of code. For example, a tag can comprise a transparent GIF or a tracking pixel, which is placed within the code of a webpage.

As a result, one embodiment of the present invention applies a reward system, wherein the user is compensated for providing data. Through advanced algorithms and a data analysis, the open source network may autonomously deploy a rewards system to incentivize users to provide additional data.

The systems and methods disclosed herein allow publishers, to monetize their user bases and more effectively. In other words, the system and method disclosed herein allows a publisher to easily track how advertisement and other targeted content or actions are affecting their user base. Armed with the quantifiable and objective information of how well targeted content and advertising is received and reacted to by a publisher user base, a publisher can charge higher prices to advertisers that utilize the publisher for advertising or promoting content. A publisher may also be able to charge higher prices to advertising customers based on voluntary data provided by a user. The customization of the systems and methods disclosed herein also offers a significant advantage. The system creates the opportunity for the publisher to create a new economy around their inventory, i.e. their users, where the network may define new ways in which to bid up the most sought-after or niche prospective user. It can be an exchange where the economy is based on expression and action, and it may cost advertisers more to reach the best authors or crowd segments in the highest demand.

Advantageously, the system functionality described herein may help publishers surface important new paid and organic marketing opportunities for their advertisers, as well as valuable remarketing opportunities for advertisers to target the same crowd again with a new message at a certain time. Furthermore, another advantage of this system may be the improvement of user experience through better native advertising and more relevant ads. The provision of these and other benefits may help attract new advertisers or retain existing advertisers. The system may also increase the size and frequency of ad buys, and incentivize the perpetuation of spend among current advertising customers.

Performance metrics that may be generated by the open source network related to the activities of a custom the user may provide deeper context around campaign engagement. Such insights, that may be both qualitative and quantitative in nature, may enrich the return on investment that a publisher is capable of demonstrating to a prospective advertiser and thusly differentiate that publisher's ad products from those of other major publishers. That is, a publisher using the system and methods described herein may be at an advantage in securing greater advertising spend or “share of wallet” due to the richness and effectiveness of the advertising experience provided.

Another advantage of the system and method disclosed herein can be exploited by brands and brand managers, as well as by their advertising agencies. Similar to how publishers may exploit the systems and methods disclosed herein, brand managers and other marketers may be able to cause maintained or increased spending in advertisements with the objective and quantifiable information that can be provided by the system and methods disclosed herein. This advantage is important because other forms of tracking the effectiveness of advertising (such as counting the number of clicks a banner advertisement on a web page gets) may not as accurately reflect the effectiveness of advertising. For example, robots may represent some of the clicks on a banner advertisement or other promoted content and may not accurately reflect the number of human users that select an advertisement. Furthermore, a user may accidentally click a banner advertisement and may never be truly interested in the advertisement. The present system and method adds more contextual information and gives quantifiable gains and returns for advertising.

The system may also include capabilities for benchmarking and ongoing monitoring. The system can provide a data specific information to each publisher to pass to an advertiser. that acts as a dashboard monitoring the activity of the advertiser's crowds on each advertising medium. This information may include any type of market share-like key performance indicators (KPIs), such as percentages of awareness, purchase intent, content relevance, crowd membership growth and crowd penetration, advertising fatigue, priming indicators, degree of topic or brand affinity, loyalty rates, crowd acquisition rates, etc.

The present system and methods allows a user to target and analyze the activities of authors across multiple publishers. As a result, the system also has the capability of facilitating both the targeting and retargeting of users across multiple ad exchanges. That is, finding and serving promotional content to the same person when he or she is on each platform. The system can thus function as a neutral third-party platform between publishers, all parties share equal information and benefit from increased advertising interest.

The use of an open source network can further aid in the determination of the recommended floor price can be based on the user and bid data. As an addition or alternative, a data science center can provide a floor price reserve which can factor in historic information obtained from the user. For example, the recommended floor price can be increased if one or more of the users has known to act on certain targeted impressions. Likewise, floor can be changed if the data indicates that the user in a particular auction has not historically acted on ad impressions.

An open source network can also help achieve improved results for publishers providing advertisement impressions to previously unidentified users. Statistical analysis of one or multiple similar users can help set accurate floor prices for new users. For example, the user information can identify comparable data from prior auctions with similar users, including the winning price at which such impressions were sold, the floor prices in those auctions, and other information which may indicate the relative value of a given user. Furthermore, in some variations, the information can be supplemented with external records, in order to obtain further information about users. Based on information obtained from multiple possible data points, a statistical analysis of potential floor prices can be obtained. Additionally, the statistical analysis can be weighted to account for information known about the users, such as number of impressions accessed on over a period of time, types of impressions a user accessed, and the frequency of access based on geographic location.

Moreover, predictive information can be determined for an auction based on the user information. In one implementation, auction analysis component, for example, can use profile information about the particular user to determine predictive information about the price floor on an ongoing and real-time basis. The predictive information, as determined by the auction analysis component, can include determining a qualitative or quantitative assessment as to whether the auction will succeed. As an alternative or addition, the determination as to whether the auction will succeed can include determining the likelihood that the winning bidder will follow through with a transaction after the auction is complete (e.g., execute act on an advertisement, provide payment etc.) once the auction is over. For example, in the case of the sale of products, a determination can be made that a given user has a strong historical record of following through with a purchase after the auction is complete. Alternatively, the determination can be made that one or more users participating in the auction have a week historical record of following through with a purchase after winning auctions.

Based on historical profile information of the participating users, the data analysis component can communicate a determination to the advertisers as to whether the transaction will likely close once the auction is over. This information can be useful to the advertiser for a variety purposes, such as for purpose of setting higher bids for certain users over others, or triggering a lower price floor to in order to maintain an advertiser's participation based on an assumption that the winning bidder will likely not be able to close a transaction in any case.

### BRIEF DESCRIPTION OF THE DRAWINGS

Embodiments of the invention are described in detail below with reference to the drawing figures, which form a part of this disclosure, and are incorporated by reference herein, and wherein:

FIG. 1 depicts an illustrative operating environment suitable for practicing an embodiment of the invention;

FIG. 2 depicts a block diagram illustrating certain methodologies for conducting an online advertising auction;

FIG. 3 depicts a block diagram illustrating certain methodologies for conducting an online advertising auction;

FIG. 4 depicts an illustrative diagram of one embodiment of the invention;

FIG. 5 depicts a block diagram of one aspect of the present invention.

### DETAILED DESCRIPTION OF THE PREFERRED EMBODIMENT

The present invention will be understood from the following detailed description of preferred embodiments, which are meant to be descriptive and not limiting. For the sake of brevity, some well-known features, methods, systems, procedures, components, and so on, are not described in detail.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” and/or “consisting essentially of”.

Programmatic advertising is a process that allows for the automated buying and selling of media inventory. The advent of ‘programmatic’ has allowed countless publishers to monetize advertising content without having to employ a large number of direct salespeople to call or brands and agencies. In fact, programmatic has become so large that it dwarfs direct-sold campaigns in terms of a volume, with nearly 180 billion impressions being served each day. This vast scale of automated buying and selling of publishers' ad inventory is facilitated by a variety of players with the three most crucial being Supply Side Platforms (“SSP”), Demand Side Platform (“DSP”), and Data Management Platform (“DMP”).

SSPs, DSPs, and DMPs provide the framework by which the “pre-bidding process” is completed. SSPs use DMPs to collect and analyze the large amounts of data collected from various sources. SSPs provide a forum for publishers to participate directly in the ad exchange between advertisers and publishers. Finally, DSPs work with the SSPs and DMPs to purchase the space from a publisher. Together, these three elements support real-time bidding and allow buyers the ability to value inventory on an impression-by-impression in real time.

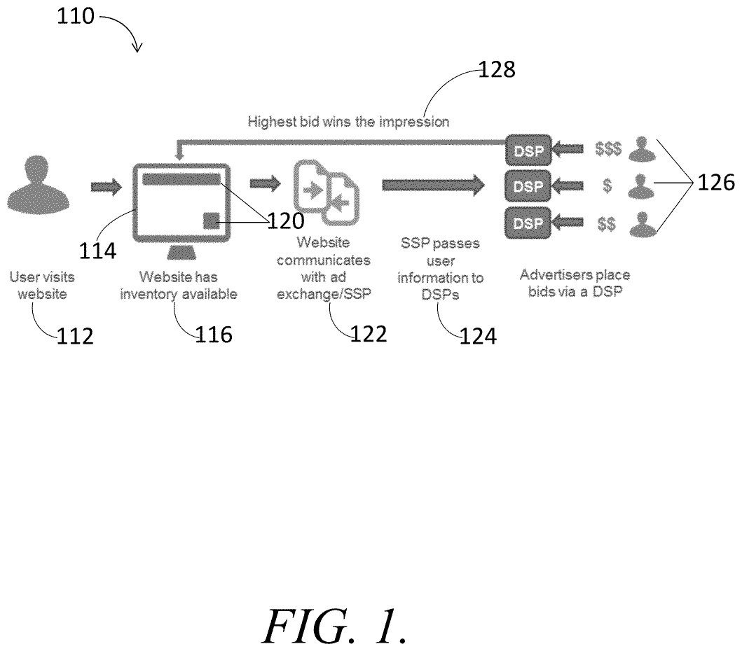

With reference to FIG. 1, a diagram illustrating this method is provided and referenced generally with the numeral 110. The pre-bidding process begins when an end user 112 uses a device 114 to visit a website that has ad inventory available 116. We show, by way of example, the end user's device 114 with a webpage 116 showing one advertising unit along the top of the web page as well as an ad unit along the side of web page 120. We will later refer to a particular ad unit by way of illustration. Ad units 120 are reservoirs to present advertising content on web page 114. Although we use the term “advertising content” we mean to include within the scope of that term more than just advertisements. By way of example, some other illustrative items might include definitions, hyperlinks, or any other type of information that might be relevant to various items of content or portions thereof. We will use the term “advertising content” or just “ads” to help reduce wordiness. Thus, ad units 120 can be any placeholder to receive ads.

As depicted in FIG. 122, the website requests an ad publisher, or SSP, to provide the web page with advertisements to fill the advertising units 120. We might variously refer to publishers as a content provider, a web-page provider, or the like. In some embodiments, the publisher is the content owner. The publisher can be any entity ranging from an individual with a small website or a personal blog to an international company or organization with a comparatively more sophisticated website.

In one embodiment, the SSP passes user information to DSPs as shown in numeral 124. This user data is collected through “cookie syncing,” or any other data collection approach. The DSPs present the user data to advertisers and further provide a method by which they can bid and compete to for their ad impression to be placed on the ad reservoir 120. Based on the winning bid, the publisher makes a call to the appropriate ad server to display the impression on the site 128.

In one embodiment, a publisher can communicate with an ad exchange is through a process known as “Header bidding.” Header bidding, also known as advance bidding or pre-bidding, is an advanced programmatic technique that has become hugely popular in the last few years wherein publishers offer inventory to multiple SSP's simultaneously before making calls to their ad servers and going through bid logic.

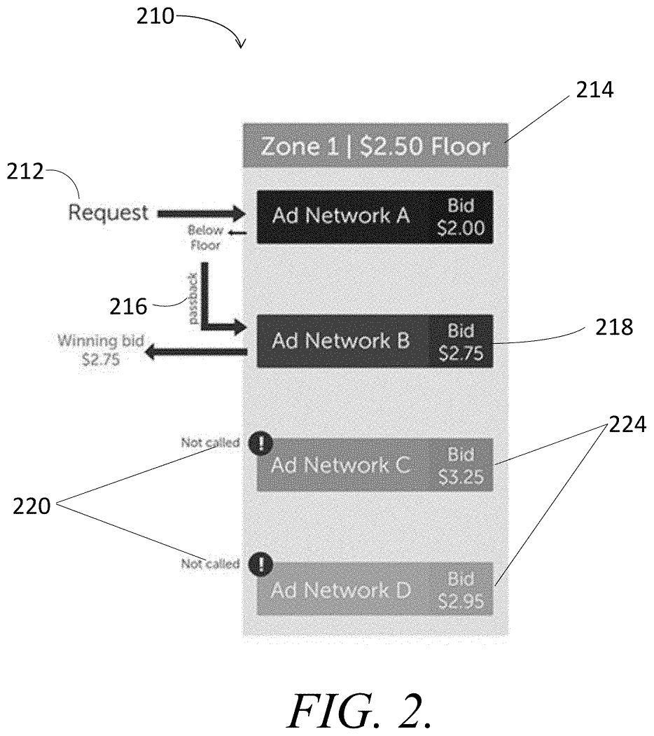

In one embodiment of the present invention, winning bid determined through a process referred to as a “waterfall auction.” With reference to FIG. 2, which is commonly referred to with the numeral 210, a Waterfall Auction the user data and a request for an ad is sent to one ad network 212 at a time. If the ad network's presents a bid that is below a pre-determined bid floor 214, the bid is rejected and passed to the next ad network 216.

As seen in FIG. 2, Once the winning bid is determined 218, the process ends. The remaining ads 220 are never called, regardless of their bid value, 220. This can sometimes result in a less desirable result, since bids greater than the winning bid, shown only as an exemplar as numeral 224, may not be considered.

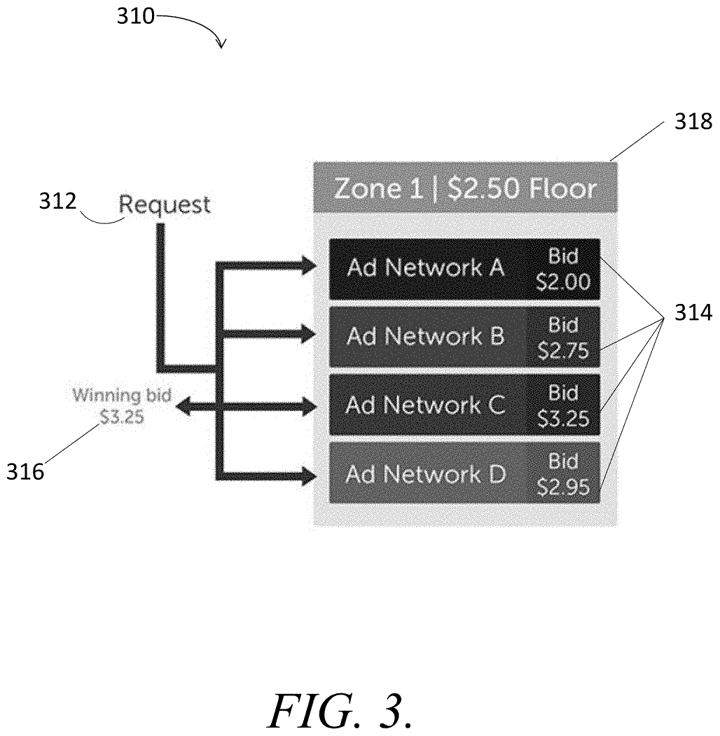

In another embodiment, the winning bid is determined through a process known as a “Header Auction.” In a Header Auction, the wrapper sources bids from multiple advertisement networks at the same time. As depicted in FIG. 3, shown as numerical 310, in a Header Auction, a request 312 is made to multiple advertisement networks which present their bids simultaneously 314. The winning bid is determined by the largest bid value over the bid floor from all of the advertisers 316.

A key aspect of the present invention, is its open source network, which analyzes and uses previously unavailable data to improve the pre-bidding process. By analyzing historical data on winning bids, publishers can improve profitability through dynamic floors, targeted and advertisements. Moreover, the historical data is analyzed to provide a more efficient and fluid auction.

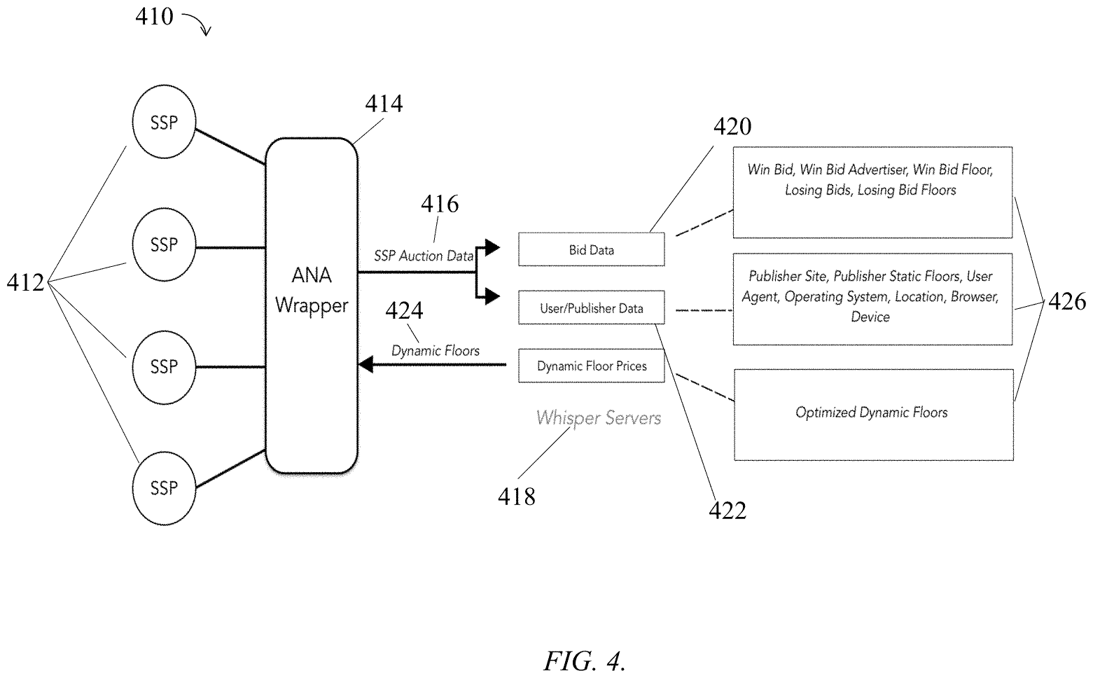

In one embodiment, shown in FIG. 4, which is commonly referred to with the numeral 410, the wrapper (“AdCash Wrapper”)414 analyzes winning bids from multiple SSPs 412. After the winning bid is determined through either a Waterfall or Header Auction approach as described supra. The auction data 416, which includes, without limitation, Bid Data 420 and User/Publisher Data 422, is further passed to an open source network 418. In addition, the auction bid data 420, and/or User/Publisher Data 422 is analyzed by a computing system, and used to adjust the price floor in the wrapper 414 dynamically 424. This dynamic bid data is used to improve the bid results in real time.

The use of a public network also provides key advantages. In particular, as the user continues to browse the internet, each subsequent winning bid and its associated metadata gets passed to the network, creating an expanding pool of user bid data 426. This level of “shared” auction data has been previously unavailable to advertisers. The system receiving the bid and user data will compromise at least one processor and at least one memory storage device capable of analyzing the data in order to optimize the bidding process. The system will be further configured to provide access to the optimized data to any publisher.

In order to incentivize publishers to participate in the public network and share auction data and user data, one embodiment of the invention uses a public network that incorporates an autonomous reward system (“AdCash Publisher Engine”). The reward, or “AdCash,” can be in the form of virtual currency, fiat currency, or any other asset of value. The rewards, or “AdCash” can be both distributed to participants, or purchased through the network.

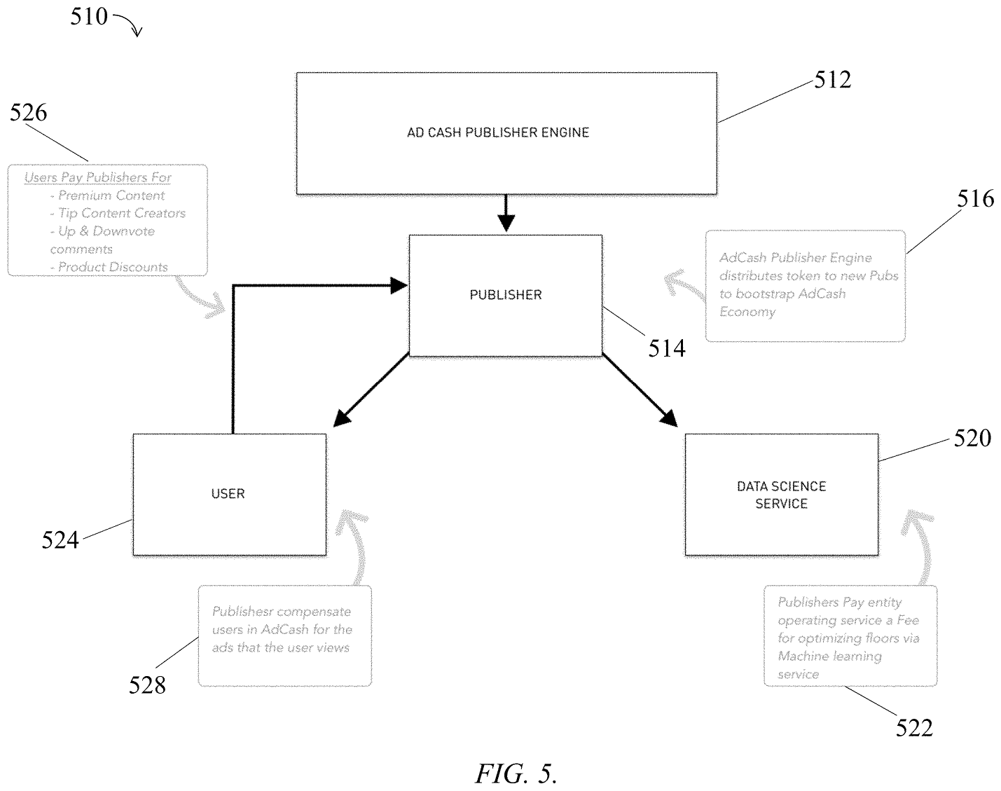

As detailed in FIG. 5, which is more commonly referred to herein using the numeral 510, the AdCash Publisher Engine 512 will be a distribution network for the rewards and data. The AdCash Publisher Engine can distribute AdCash to new Publishers 514 entering the network. Such a distribution can be a method to bootstrap the AdCash network and ecosystem 516.

In one embodiment, the bid data is analyzed by a centralized network (“data or science center”) 520, which is capable of analyzing the data and optimizing the price floor 522. The data or science center further capable of receiving flat currency, AdCash or other virtual currency in exchange for the using at least one processor and a memory unit to analyze and optimize the bid and user data.

In order to improve the auction, the users can be identified and categorized prior to the auction. This historical information can be shared amongst publishers to allow a “pre-auction” so that the publishers can conduct their due diligence on a particular user or user group. Moreover, the publishers will know the typical values required that were winning bids for a specific user, or user group.

The data analysis can include components related to improving the pre-bidding process. Users can be analyzed as both individuals as groups. The profile of individual users can include a quantitative and/or qualitative assessment of each user as a target of impressions in auctions. According to one aspect, the profile can include or correspond to a score, which quantitatively assesses the user based on likelihood to click on a particular impression, and likelihood or likelihood to subscribe to a particular service, or purchase a good. In addition, the click through rate of a particular user can be correlated to an interest metric. In one implementation, the historical data analysis component correlates the detected click through rate to some metric of interest which is indicative of an amount of interest by individual users who are sought after for impressions. The metric can be determined to be specific for an individual user, or can be indicative of the interest level of a type of user based on characteristics. For example, a high click through rate by a user in a particular location, or based on a particular demographic or age group, the interest level of all similar users. This in turn can be used to provide more accurate price floors and improved auctions. Moreover, in one embodiment, a class of users can be specified and categorized with a predicted winning bid price.

In another embodiment, the end user 524 can also participate in the pre-bidding process, by either limiting the data provided to publishers 526, and/or being compensated for providing viewing advertisements 528. The end user 524 can be compensated through use of, without limitation, digital tokens, virtual currency, or fiat currency as compensation for sharing their data.

In one embodiment of the present invention, the header bidding wrapper will have the ability to translate the user data into universal parameters that can be sent with each ad request when a user is on a site that uses the wrapper. Additionally, users may have the option of licensing the data direction to specific DMP partners sot they will be rewarded whether or not they visit a site that has the wrapper implemented. Under such circumstances, users will benefit directly not only by accelerating their rewards, but also by seeing more relevant and appropriate advertising.

In one embodiment, users will have the ability to scale back the number of advertisements, and thereby limit the amount of data they are sharing with advertisers

In order to further align the interests of advertisers, publishers, and users, publishers, one embodiment allows users to receive greater compensation for the more data that users are providing. The following formula can be used to determine how much reward should be given to publishers:

P=A−{I*(1−F)−U}

Wherein:

a. P=Publisher Allocation

b. A=Advertsier Bid

c. I=revenue uplift due to the wrapper

d. F=AdCash Network fee

e. U=User allocation of the Advertiser bid

In another embodiment of the present invention, the wrapper autonomously withholds a percentage of the increase in yield that is provided to Publishers, via a tiered Fee structure that lowers as more of the Publishers users begin to volunteer data.

The following equation can be used to determine the User carve out of the rewards:

U=Y*{(Z*CPM)/1000}

### Wherein:

a. U=User Carveout
b. Y=Percentage allocation of the advertiser's bid
c. Z=Daily impressions of the given user
d. CPM=the average win-bid cost-per-thousand-impression that SSPs are returning to the AdCash Wrapper

In an alternative embodiment, a custom search monitor may be applied by a user to improve the frequency, timing and relevance of impressions. By accessing a database of information from different publishers, the present technology requires a data processing system with sufficient memory and processing power to store and recall user data in real time. In addition, the invention may be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups. In particular, the open source network discussed herein must be capable of analyzing user and bid data in a manner that can optimize the bidding process.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removable or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

What is claimed is:

1. A system, the system comprising:
At least one server, the server containing at least one processor, and at least one non-transitory machine readable storage medium;
The at least one server capable of receiving a request to present a webpage, wherein the webpage includes one or more areas to present advertisements and the website further configured to autonomously execute programmatic code upon receiving the request to present the webpage;
The programmatic code configured such that, when executed by the at least one processor sends data from an end user device to the a at least one advertisement publisher;
The server further configured to:
receive bid data from at least one advertiser;
analyze the bid data to determine a winning bid;
send a request to an advertisement server to display an advertisement impression on the website;
update programmatic code parameters regarding a bid floor;
send the user data and the bid data in an open source network.

2. The system according to claim 1, wherein the open source network is configured to allow at least one third party access to the end user bid data.

3. The system according to claim 1, wherein the open source network is configured to allow at least one third party access to the auction bid data.

4. They system according to claim 1, wherein the end user data is collected through cookie syncing.

5. The system according to claim 1, wherein the end user can volunteer to provide data.

6. The system according to claim 3, wherein the program instructions are configured to allow end user can provide additional data through a survey.

7. The system according to claim 3, wherein the program instructions are configured to allow end user to provide additional information through location permissions.

8. The system according to claims 4, wherein the end user is rewarded.

9. The system according to claim 7, wherein the end user is rewarded in the form of virtual currency.

10. The system according to claim 8, wherein the end user is rewarded with FIAT currency.

11. The system according to claim 1, wherein the end user can limit the amount of data sent from the end user device.

12. The system according to claim 3, wherein the end user can license data to specific data sources.

13. The system according to claim 1, wherein a Publishers compensation (P) comprises an advertiser's bid (A), a change in revenue for using the system (I), an additional network fee (F), and a reward associated with the advertiser bid (U).

14. The system according to claim 12 wherein executing the program instructions further comprises determining the publisher's compensation as A−{I*(1−F)−U}.

15. The system according to claim 6, wherein the end user's reward comprises a percentage of an advertisers bid (Y), a daily impression presented to a given user (Z); an average win-bid cost-per-thousand impressions that supply side providers are returning (CPM).

16. The system according to claim 14, wherein executing the program instructions further comprises determining the User reward as Y*{(Z*CPM)/1000}.

17. The system according to claim 1, wherein the winning bid the highest value bid above the bid floor.

18. The open source network according to claim 19, configured to provide an updated bid floor value using a computation involving the end user data and the auction bid data.

19-77. (canceled)
